(19) United States
(12) Patent Application Publication
(10) Pub. No.: US 2015/0000686 A1
(43) Pub. Date: Jan. 1, 2015

(54) FINGER PALETTE

(71) Applicant: LaVaque Enterprises LLC, Stevens Point, WI (US)

(72) Inventors: Sunil Bajaj, New Delhi (IN); Barry J. LaVaque, Murrieta, WI (US)

(21) Appl. No.: 14/490,835

(22) Filed: Sep. 19, 2014

Related U.S. Application Data
(63) Continuation of application No. 13/411,552, filed on Mar. 3, 2012, now abandoned.
(60) Provisional application No. 61/464,650, filed on Mar. 7, 2011.

(51) Int. Cl. B44D 3/02; A45D 33/26

(52) U.S. Cl. CPC B44D 3/02; A45D 33/26
USPC 132/200

(57) ABSTRACT

The present invention relates to a palette attachable to a finger. The palette facilitates transfer of a product from a container to a work surface by serving as an intermediary surface. By attaching to a finger, the palette provides the user with freedom to use both hands while applying the product.

### CROSS-REFERENCE TO RELATED APPLICATIONS

This application is a continuation of U.S. patent application Ser. No. 13/411552 filed Mar. 3, 2012, which claims priority under 35 USC §119(e) to U.S. Provisional Patent Application 61/464,650 filed Mar. 7, 2011, both of which are incorporated by reference herein.

### FIELD OF THE INVENTION

The present invention relates to a palette attachable to a finger, where the palette serves as an intermediary for the transfer of products from a container to a working surface.

### BACKGROUND OF THE INVENTION

Artists have used palettes to arrange and mix paints for hundreds of years. Palettes are also used by makeup artists for applying cosmetics. A palette for cosmetics can be a substantially flat surface on which cosmetics are arranged and mixed. The palette serves as an intermediary for transferring cosmetics, such as makeup, from a container to a user's body. The palette is commonly made of stainless steel and held in the user's hand, thereby providing a durable work surface to scrape, mash, mix and blend cosmetics with pressure and speed.

### BRIEF DESCRIPTION OF THE DRAWINGS

FIG. 1 is perspective view of an example finger palette.

FIG. 2 is perspective view of an example finger palette.

FIG. 3 is perspective view of an example finger palette.

FIG. 4 is a perspective view of an example surface portion of a finger palette.

FIG. 5 is a perspective view of an example ring portion of a finger palette.

FIG. 6 is a perspective view of an example finger palette attached to a user's thumb.

FIG. 7 is a perspective view of an example finger palette attached to a user's index finger.

FIG. 8 is a perspective view of an example finger palette having a curved surface portion and cosmetic product (such as makeup) thereon.

FIG. 9 is a perspective view of an example finger palette having a magnetized surface portion and fasteners (such as for hair) secured thereon.

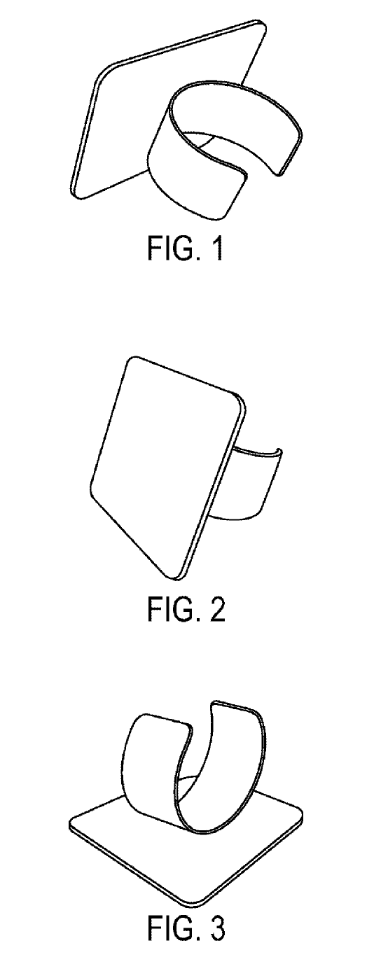

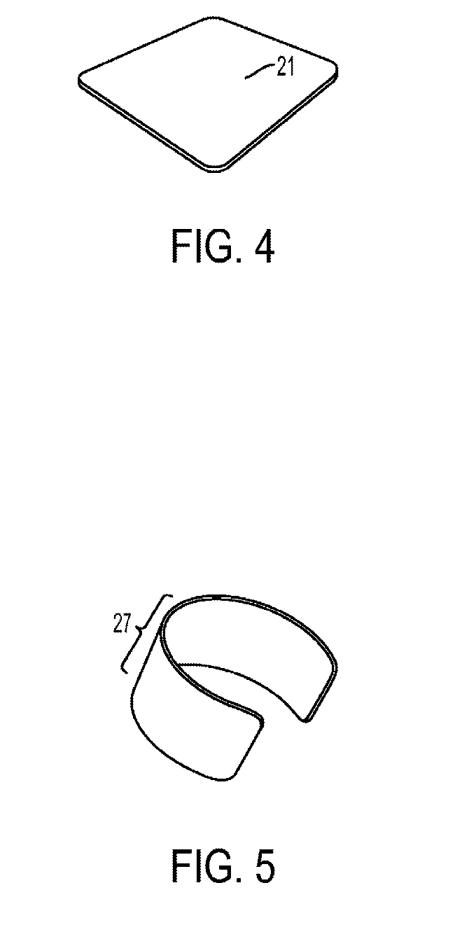

### DETAILED DESCRIPTION OF PREFERRED VERSIONS OF THE INVENTION

Natural oils from a user's skin can contaminate a product in a container, such as cosmetics. This often occurs when an applicator is used to transfer the product directly from the container to the user's skin. To prevent contamination, there is a need for improved hygiene. Contamination can be avoided by using a palette as an intermediary, and the products can be transferred from the container to the palette using a spatula. For example, applying makeup from a palette, rather than a container, prevents natural oils from contaminating and chemically altering the makeup in the container. Using a palette also prevents cross-contamination between separate containers, thereby extending the life of the cosmetics and ensuring professional-level sanitation.

By using a palette and spatula, the risk of cross-contamination is eliminated, because the applicator is not inserted into a container of cosmetics. Instead, the spatula is used to transfer cosmetics from the container to the spatula before the application process begins. The surface of the palette is then used to scrape, mash, mix and blend cosmetics with pressure and speed. Once custom blending is achieved, the user can then transfer the cosmetics directly from the palette to the skin by using a brush, sponge, puff or other disposable applicator. When finished, the palette can be cleaned and sanitized with a cleansing product and tissue or other suitable products or methods.

Prior to the present invention, it was common for the user to hold the palette in a first hand and an applicator in a second hand while applying makeup. As a result, the first hand was occupied at all times while holding the palette. This approach left only the second hand available for applying cosmetics or other tasks. As a result, additional time was required to apply cosmetics, and the user's ability to multitask was limited.

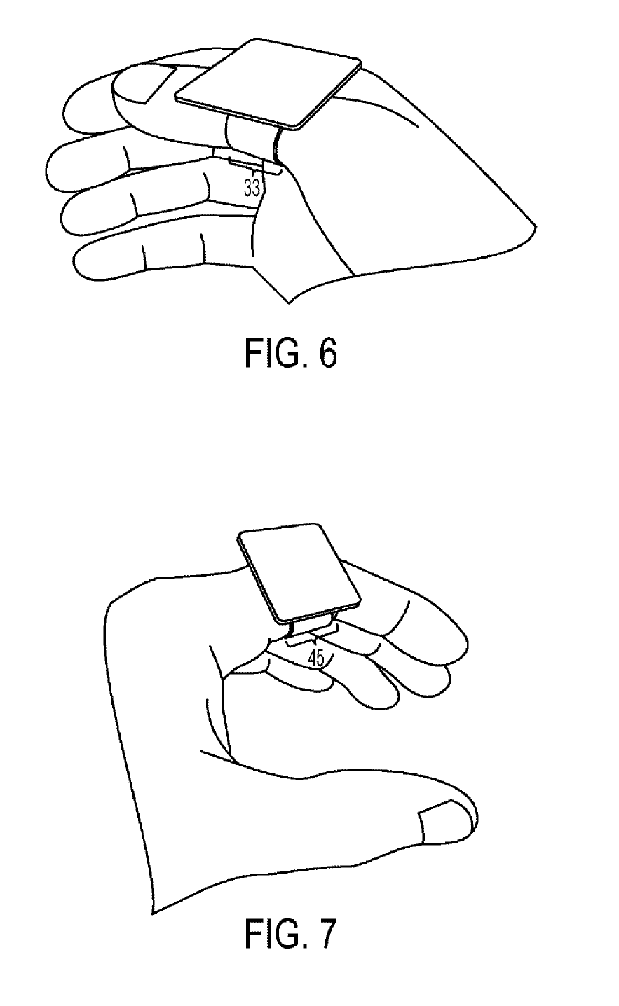

The present invention allows the user freedom to use both hands when applying a product. This is accomplished by creating a palette that attaches to the user's finger. The palette can attach to any finger, but preferably the palette attaches to the user's thumb or index finger, as shown in FIGS. 6 and 7, respectively. The finger palette can include a surface portion 21 attached to a ring portion 27. The surface portion can be made of metal, wood, plastic, composite, fabric, nylon, leather, ceramic, or any other suitable material. The finger palette can be reusable or disposable. Preferably, if the finger palette is reusable, it is desirable to use a material that is durable and can be sanitized using conventional methods such as sanitation fluids or an autoclave. In one example, the surface portion can include stainless steel.

The surface portion 21 can have any suitable shape. For example, the perimeter of the surface portion can be round, square, oval, rectangular, polygonal, or any combination of lines and curves. The surface portion can have any suitable size capable of receiving a product. The surface portion can have dimensions of approximately 3 inches by 2 inches, 2 inches by 2 inches, 2 inches by 1 inch, 1 inch by 1.25 inches, 1 inch by 1 inch, 0.5 inches by 0.5 inches, or any other suitable dimensions. Consequently, the surface portion can have a top surface area of 0.25 in² to 1 in², 0.25 in² to 1.25 in², 0.25 in² to 2 in², or 0.25 in² to 4 in², 0.25 in² to 6 in², 4 in² to 6 in², 2 in² to 6 in², 1.25 in² to 6 in², or 1 in² to 6 in². The surface portion can have any suitable thickness ranging from, for example, a few thousandths of an inch (i.e. 0.003 inch) to 0.5 inches, depending on the material. For example, the surface portion can have a thickness of 1/32 to ¼, 1/32 to 3/16, 1/32 to ⅛, 1/32 to 1/16, 1/16 to ¼, ⅛ to ¼, 3/16 to ¼, or ¼ to ½ of an inch. In one example, the surface portion can be stainless steel having a thickness of approximately 1/16 of an inch. The dimensions of the surface portion can be adjusted to accommodate user preferences and various types of products. In one example, the surface portion can provide a work surface to blend cosmetics against.

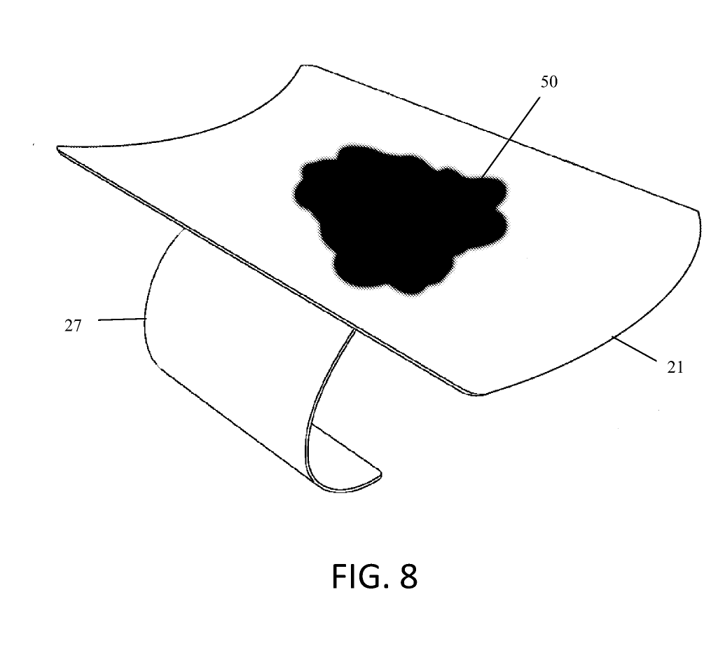

The surface portion 21 can be flat or curved, as shown in FIG. 8. A flat surface can be useful for wet products 50, whereas a curved surface can be useful for wet or dry products 50. Wet products can include, for example, nail polish, paint, or liquid foundation. Dry products can include, for example, powders, such as a powder foundation. The surface portion can have a concave portion that retains dry products and prevents spillage over the edges of the surface portion. Preferably, the concave portion is free of seams or edges that could trap the products and complicate cleaning or sterilization processes. The concave portion can be curved like an inner surface of a sphere, elliptic paraboloid, or any other suitable surface or shape. The surface portion can include a combination of flat and concave portions.

The ring portion 27 can be made of metal, wood, plastic, fabric, nylon, leather, composite, elastic, ceramic, or any other suitable material. The ring portion can have any suitable shape that allows the palette to attach to a user's finger. For example, the ring portion can have an inner diameter ranging from 0.4 inch to 1.0 inch. The ring portion can be fitted to a user's finger or adjustable to fit a variety of finger sizes. For instance, a larger inner diameter of the ring portion 33 can be suitable for attaching to a thumb, as shown in FIG. 6, whereas a smaller inner diameter of the ring portion 45 can be suitable for attaching to an index finger, as shown in FIG. 7.

The ring portion 27 can employ any suitable clamping mechanism for attaching the palette to the user's finger. For instance, the ring portion can be a metallic ring as shown in FIG. 5 containing a gap to allow for size adjustment. The ring portion can be sufficiently ductile to allow a user to adjust the size of the ring portion by hand and without the need for tools. Alternately, the ring portion can include VELCRO, DUAL LOCK, or any other type of re-closeable fastener. The ring portion can include a pad on its inner surface to improve comfort. The pad can be formed from any suitable material, such as a fabric, leather, gel, or rubber. For reusable finger palettes, the pad can be removable to facilitate sanitization processes. The pad can extend around the circumference of the inner surface of the ring portion. Alternately, one or more pads can be placed at suitable locations on the inner surface of the ring portion.

The ring portion 27 can be attached to the surface portion using any suitable joining technique. For example, if the ring and surface portion are metallic, then welding, brazing, or other similar joining techniques can be used. In one example, the surface portion can be spot welded to the ring portion. Adhesives, fasteners, or ties can be used to join the ring portion to the surface portion. In another example, the surface portion and ring portion can be a formed as an integral piece. For instance, the surface and ring portion can be molded as a single piece of metal or plastic.

To use the finger palette, the user can slide the palette onto a finger. The finger palette provides the user with a durable working surface to scrape, mash, mix and blend makeup with pressure and speed. Because the finger palette attaches to a finger and does not need to be held, both of the user's hands are available to assist in the application of the makeup or other activities, such as holding and using a cell phone. Before applying makeup, the user will use a tool, such as a spatula, to remove the makeup from the container and transfer the makeup to the finger palette. The user can then scrape, mash, mix or blend the makeup against the surface portion. Once product mixture or custom blending is achieved, the user can then use the finger palette as a work surface for applying makeup directly to the skin by using a brush, sponge, puff or other disposable applicator.

The finger palette can also be used by a first person to apply products to a second person. For instance, a professional makeup artist can attach the finger palette to their finger to aid in applying products to a client. The makeup artist can transfer products from a container to the finger palette using a spatula or other suitable device. If desired, the makeup artist can then add additional products to the finger palette and blend the products on the palette before applying them to the user. After the makeup artist has finished applying products to the client, the finger palette can be deposited into sterilization fluid to sanitize it for the next client.

The finger palette can be used with any suitable product, such as cosmetics, lotions, paints, finger nail polishes, foods, art supplies, cleaning solvents, solder pastes, lubricants, epoxies, etc. In one example, a nail technician can use the finger palette for finger nail polish. In another example, an artist can use the finger palette for paint. In another example, a baker can use the finger palette for cake decorating frosting. In another example, an auto repairman can use the finger palette for epoxy while repairing a chip in a vehicle's windshield. In another example, an assembly line worker can use the finger palette for solder paste while assembling an electronic device. In these examples, the finger palette serves as a convenient, low-cost, portable tool. This list of examples is not limiting; other applications for the finger palette are contemplated and will be readily apparent to those skilled in the art.

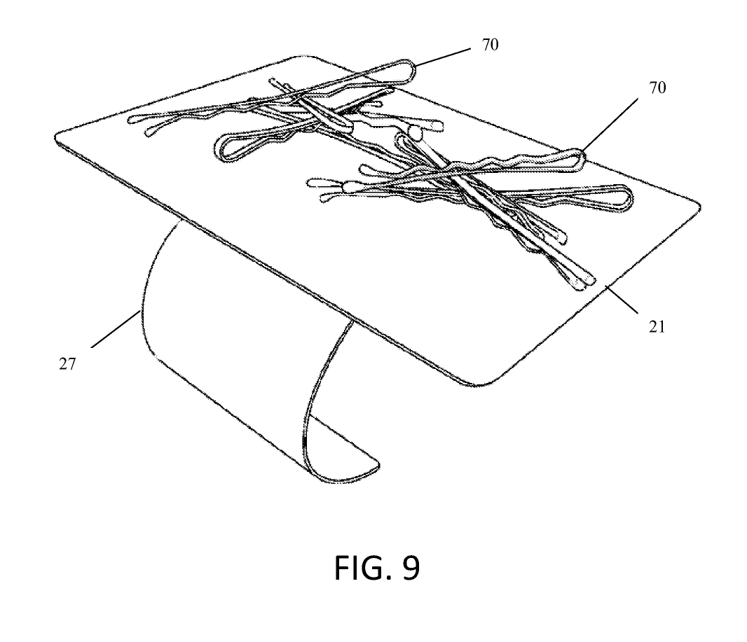

As shown in FIG. 9, the finger palette can include a magnetized material to allow it to retain small metallic parts 70. For example, the surface portion 21 of the finger palette can be magnetized. In one example, a magnetized finger palette can be used by a watch repairman while repairing a movement in a watch. As the repairman removes tiny screws from the watch, he can place them on the finger palette to prevent losing them. The finger palette can include an image on the top surface of the surface portion. For instance, the finger palette can include an image showing the internals of a watch. The repairman can then position the screws in locations on the finger palette corresponding to where they were removed from the watch. This can simplify the reassembly process and ensure that no screws are lost. The image can be unique for each brand and model of watch. The image can be removable and/or reusable. In another example, the image can be permanent or semi-permanent. For instance, the image can be painted, printed, etched, or laser scribed on the surface portion. In another example, the image can be a removable plastic film layer. Other applications are contemplated. For example, an eye care professional can use the magnetized finger palette to retain small screws while repairing a pair of eyeglasses. In another example, an auto mechanic can use the magnetized finger palette to assist in retrieving a difficult to reach nut or bolt within an engine bay. Likewise, a magnetized finger palette can be used for any other suitable application.

Details of one or more embodiments are set forth in the accompanying drawings and description. Other features, objects, and advantages will be apparent from the description, drawings, and claims. Although a number of embodiments of the invention have been described, it will be understood that various modifications may be made without departing from the spirit and scope of the invention. It should also be understood that the appended drawings are not necessarily to scale, presenting a somewhat simplified representation of various features and basic principles of the invention.

What is claimed is:

1. A method of using a finger palette to transfer cosmetics from a container to a destination,
a. the finger palette including:
i. a ring portion that is securable to a finger; and
ii. a surface portion secured to the ring portion, the surface portion being at least substantially smooth to allow a user to spread or blend cosmetic product on the surface portion;
b. the method including the steps of:
i. securing the finger palette to a finger;
ii. depositing a cosmetic product onto the surface portion of the finger palette; and
iii. transferring the cosmetic product from the surface portion of the finger palette to a destination.

2. The method of claim 1 further including the step of removing the cosmetic product from a container before depositing the cosmetic product onto the surface portion of the finger palette.

3. The method of claim 2 wherein:
a. the cosmetic product is removed from the container using a first instrument; and
b. the cosmetic product is transferred from the surface portion to the destination using a second instrument.

4. The method of claim 1 wherein:
a. a first quantity of the cosmetic product is deposited onto the surface portion; and
b. a second quantity of the cosmetic product is transferred from the surface portion to the destination, the second quantity being smaller than the first quantity.

5. The method of claim 1 wherein:
a. the surface portion extends outwardly from a surface center to an outer perimeter; and
b. the surface portion is free, from any first point on the outer perimeter to any second point on the outer perimeter, of features that could trap cosmetics and complicate cleaning of the surface portion.

6. The method of claim 1 wherein the surface portion is at least substantially without protrusions extending therefrom.

7. The method of claim 1 wherein the surface portion is at least substantially planar.

8. The method of claim 1 wherein the surface portion has a surface area between at least substantially 0.5 inches squared and at least substantially 6 inches squared.

9. The method of claim 8 wherein the surface portion has a surface area between 0.5 inches squared and 2 inches squared.

10. The method of claim 1 further including the step of spreading the cosmetic product on the surface portion before transferring the cosmetic product from the surface portion to the destination.

11. The method of claim 1 wherein the finger palette is secured to the finger by passing the finger through the ring portion.

12. The method of claim 1 wherein:
a. the cosmetic product is a first cosmetic product; and
b. the method further includes the step of depositing a second cosmetic product onto the surface portion of the finger palette.

13. The method of claim 12 wherein:
a. the first cosmetic product is deposited on a first segment of the surface portion; and
b. the second cosmetic product is deposited on a non-overlapping second segment of the surface portion.

14. The method of claim 12 further including the step of blending the first cosmetic product with the second cosmetic product on the surface portion to obtain a blended cosmetic product.

15. The method of claim 14 further including the step of transferring the blended cosmetic product from the surface portion of the finger palette to the destination.

16. The method of claim 12 wherein:
a. the first cosmetic product is removed from a first container and deposited on the surface portion using a first instrument;
b. the second cosmetic product is removed from a second container and deposited on the surface portion using a second instrument; and
c. the cosmetic product is transferred from the surface portion to the destination using a third instrument.

17. The method of claim 1 wherein:
a. the cosmetic product is nail makeup; and
b. the destination is a fingernail.

18. A method of using a finger palette to transfer cosmetics from a container to a work surface,
a. the finger palette including:
i. a ring portion configured to be removably and replaceably securable to a finger; and
ii. a surface portion secured to the ring portion, the surface portion extending outwardly from a surface center to an outer perimeter, wherein the surface portion is at least substantially smooth so as to allow a user to scrape an applicator past the surface center in an uninterrupted motion while spreading or blending cosmetic product over the entirety of the surface portion;
b. the method including the steps of:
i. securing the finger palette to a finger by passing the finger through the ring portion;
ii. dispensing cosmetic product from a cosmetics container and placing a first quantity of the dispensed cosmetic product onto the surface portion of the finger palette;
iii. removing cosmetic product from the surface portion of the finger palette; and
iv. applying a second quantity of the removed cosmetic product to a destination, the second quantity being smaller than the first quantity.

19. The method of claim 18 wherein:
a. the cosmetic product is dispensed the cosmetics container using a first instrument;
b. the cosmetic product is removed from the surface portion using a second instrument; and
c. the removed cosmetic product is applied to the destination using the second instrument.

20. The method of claim 18 wherein:
a. the dispensed cosmetic product is a first cosmetic product dispensed from a first cosmetics container; and
b. the method further includes the steps of:
i. dispensing a second cosmetic product from a second cosmetics container and placing a third quantity of the dispensed second cosmetic product onto the surface portion of the finger palette; and
ii. blending the first cosmetic product on the surface portion with the second cosmetic product on the surface portion to obtain a blended cosmetic product, wherein the cosmetic product applied to the destination is the blended cosmetic product.
